(19) United States
(12) Patent Application Publication
(10) Pub. No.: US 2023/0357899 A1
(43) Pub. Date: Nov. 9, 2023

(54) HETEROGENEOUS MICROSTRUCTURED ALUMINUM ALLOYS

(71) Applicant: UNIVERSITY OF NORTH TEXAS, Denton, TX (US)

(72) Inventors: Rajiv MISHRA, Denton, TX (US); Mageshwari KOMARASAMY, Denton, TX (US); Saket THAPLIYAL, Denton, TX (US)

(73) Assignee: UNIVERSITY OF NORTH TEXAS, Denton, TX (US)

(21) Appl. No.: 18/246,351

(22) PCT Filed: Oct. 8, 2021
(86) PCT No.: PCT/US21/54103

§ 371 Date: Mar. 23, 2023

Related U.S. Application Data
(60) Provisional application No. 63/089,238, filed on Oct. 8, 2020.

(51) Int. Cl. C22C 21/00

(52) U.S. Cl. CPC C22C 21/00

(57) ABSTRACT

Non-equilibrium conditions and distinctive process-dynamics give laser-powder bed fusion (L-PBF) inherent capability to produce unique microstructural-features. However, alloy-design strategies that not only tackle printability-related challenges but also capitalize on such inherent capability, are imperative. Hence, an alloy-design strategy that integrates concepts of grain-refinement and eutectic-solidification is proposed. Consequently, an Al-3Ni-1Ti-0.8Zr (wt. %) alloy has been designed and processed with L-PBF. The alloy exhibits a wide processing-window, indicating excellent printability, and hierarchical features-enabled heterogeneous grain-structured microstructure; a high synergistic as-built strength-ductility is thus obtained. Notably, wide processing-window allows fine-tuning of as-built microstructure, whereas heterogeneous microstructure potentially allows activation of back-stress strengthening and work-hardening.

### RELATED APPLICATIONS

This application claims priority under 35 U.S.C. § 119(e) to U.S. Provisional Patent Application No. 63/089,238 filed Oct. 8, 2020, which is incorporated herein by reference.

### GOVERNMENT SUPPORT

This invention was made with government support under Grant No. N00014-17-1-2559 awarded by the Office of Naval Research. The government has certain rights in the invention.

### BACKGROUND OF THE INVENTION

The unprecedented increase in component design space has led to significant focus on fusion-based additive manufacturing (AM) technologies. The new design possibilities integrate features and functionalities that are not supported by conventional manufacturing, and simultaneously achieve unitization of components. However, fusion-based AM suffers from a lack of diverse alloys, as conventional high-strength Al alloys are prone to hot cracking and other defect formation during printing. New alloy design approaches are being pursued to overcome these limitations. Current strategies for design of printable Al alloys for laser-powder bed fusion (L-PBF) are primarily experimental and revolve around grain refinement and eutectic solidification (ES). Each of these strategies targets hot cracking at only a specific stage of solidification. Consequently, the processing window of the alloy shrinks and fine-tuning of the alloy microstructure becomes difficult, thus prohibiting the activation of multiple deformation mechanisms. On the other hand, strategies that integrate microstructural refinement (MR) and ES attack the problem during multiple stages of solidification. Such MR+ES integrated alloy design strategies allow widening of alloy-processing-window (printability) and activation of multiple deformation mechanisms such as back-stress strengthening and work-hardening, thus producing alloys with excellent synergy of printability and performance (Materials and Design 2021, 204, 109640).

Unlike dual-phase alloys, Al-alloys often enjoy only conventional strengthening mechanisms that are constrained within the realms of strength-ductility paradigm. Fortunately, heterogeneous grain structure (HGS) can enable Al-alloys with additional mechanisms such as back-stress strengthening and back-stress work hardening and may lead to high synergistic strength-ductility in these alloys. Furthermore, the advent of disruptive technologies such as laser-powder bed fusion (L-PBF) allows producing geometrically-complex components with unique microstructural features (often not exhibited by near-equilibrium processes), and therefore gives an opportunity to obtain HGS and consequently back-stress strengthening in Al-alloys.

Interestingly, non-equilibrium cooling-rates, and large variation in temperature gradient and growth-rate across the melt-pool, which result in unique microstructural features in L-PBF, may also result in printability related-issues such as solidification cracking in Al-alloys. Hence, to design printable Al-alloys, researchers have so far implemented either strategies for grain-refinement (as used in Zr- and Sc-containing Al-alloys) or the strategies for obtaining eutectic-solidification (as used in Si-containing Al-alloys). Using grain-refinement-strategy either may improve printability when homogeneously fine grains are present throughout the microstructure, or may result in formation of regions of fine-grains and hot-cracking-susceptible columnar grains. The latter case may have smaller processing-window and thus poor printability. Conversely, using eutectic-solidification-strategy although leads to excellent printability, only homogeneously fine cellular-dendritic grain structure or homogeneously coarse grain structure can be obtained depending on the processing conditions; in either case, strength-ductility conflict impales the material. It is therefore evident that using only one strategy for designing Al-alloys for L-PBF leads to a trade-off between HGSed microstructure and alloy-printability.

Accordingly, a solution is needed for integrating grain-refinement- and eutectic-solidification-strategies into one strategy for design of Al-alloys with a) crack-free microstructure at wide range of processing parameters, i.e., excellent printability, and b) HGSed as-built microstructure, i.e., synergistic strength-ductility performance.

### SUMMARY

This disclosure provides an alloy-design strategy as follows. It is believed that addition of elements that: a) can aid in heterogeneous nucleation of fine-equiaxed α-Al grains and b) can form a eutectic with Al, may assist in developing an Al-alloy with excellent printability as well as HGSed microstructure. Grain refining phases, such as those formed by Zr in Al, “decorate” only specific sites in the as-built microstructure due primarily to distinctive process-dynamics in L-PBF such as formation of the remelting-zones. Therefore, only those microstructural sites that are “decorated” by these phases, will facilitate the formation of fine-equiaxed grains. Now, L-PBF inherently has the capability to produce long, hot-cracking-susceptible columnar grains that grow in direction opposite to the flow of heat from melt-pool to substrate. Hence, remaining microstructural sites that are not “decorated” by these grain refiners would still solidify into these hot-cracking-susceptible coarser columnar grains.

However, invoking eutectic-solidification at the terminal stage of solidification, may reduce the hot-cracking-susceptibility of the latter sites, in that a constant melting point eutectic would facilitate the availability of more liquid at the end and would lead to tensile strain accommodation and crack backfilling. Further, due to the formation of terminal eutectic the alloy would solidify at close-to-zero freezing-range at the terminal stage leading to minimal thermal strains. Therefore, a crack-free HGSed microstructure containing fine-equiaxed grains and large columnar grains would be obtained in as-built condition. Besides exhibiting excellent printability, such HGSed microstructure is also expected to exhibit high synergistic tensile strength-ductility.

Accordingly, this disclosure provides an aluminum alloy represented by Formula I:

Al—Ni—Ti—Zr (I);

wherein
Al is about 90.8 wt. % to about 98.1 wt. %;
Ni is about 1 wt. % to about 6 wt. %;
Ti is about 0.5 wt. % to about 2 wt. %; and
Zr is about 0.4 wt. % to about 1.2 wt. %.

This disclosure also provides a heterogeneous aluminum alloy comprising Al, Ni, Ti, and Zr wherein the alloy has a microstructure comprising fine grains and an intergranular region, wherein:
the fine grains comprise alpha-aluminum having a cuboidal nucleus of Al₃Ti, Al₃Zr, or a combination thereof, wherein the edge length of the nucleus is about 50 nanometers to about 150 nanometers;
   the size of the fine grains is about 0.4 to about 5 micrometers; and
   the intergranular region comprises Al—Ni eutectic lamellae.

Additionally, this disclosure provides a method for forming the aluminum alloy comprising printing a metal alloy composition of Al, Ni, Ti, and Zr by laser-powder bed fusion (L-PBF) at a suitable laser-power (P) and scanning-speed (ν) for forming the aluminum alloy according to the disclosure above.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. (a) T-Fₛ and (b) T-(Fₛ)^{0.5} curves for Al—Ni—Ti—Zr alloy obtained from SGSS.

FIG. 2. (a) Variation of relative density with ν and (b) variation of relative density with VED in specimens printed at 200 W and 350 W. (c) Reconstructed 3D-XRM image representing porosity-distribution within as-built Al—Ni—Ti—Zr alloy.

FIG. 3. (a-c) SEM images representing various features in as-built Al—Ni—Ti—Zr alloy. (d) A schematic of remelting-zones within a melt-pool. (e) As-built microstructure from F.G. region indicating nucleation of fine equiaxed grains on dispersoids.

FIG. 4. (a) STEM image and (b-e) corresponding EDS maps of as-built Al—Ni—Ti—Zr alloy.

FIG. 5. (a) Tensile behavior of Al—Ni—Ti—Zr alloy and (b) comparison of tensile properties of Al—Ni—Ti—Zr alloy with other additively manufactured Al-alloys.

FIG. 6. EBSD map of as-built Al—Ni—Ti—Zr alloy displaying a heterogeneous grain-structured microstructure.

FIG. 7. Aging response of as-built Al—Ni—Ti—Zr alloy (a) isochronally aged for 4 hrs. at different temperatures, isothermally aged at (b) 200° C. and (c) 400° C. for different time-durations.

FIG. 8. (a-q) Scheil-Gulliver solidification behavior of various compositions of Al—Ni—Ti—Zr alloys.

FIG. 9. Various regions of a T-Fₛ curve that provide information about alloy printability.

FIG. 10. (a) Schematic depicting recipe of an alloy allowing printability-heterogeneity synergy during L-PBF AM. The T-Fₛ curve depicts integration of the grain refinement and ES strategies. (b) T-Fₛ curve for Al—Ni—Ti—Zr alloy suggests formation of potent primary phases; low HSI facilitates enhanced grain bonding.

FIG. 11. (a) T-(Fs)^{1/2} curves for various alloys. (b) Comparison of as-built tensile properties of L-PBF processed alloys with Al—Ni—Ti—Zr alloy. The Al—Ni—Ti—Zr alloy exhibited E_{corr} values higher than 5083 and a higher anodic slope than 5083 indicating higher passivation tendency (not shown).

### DETAILED DESCRIPTION

Alloying additions of transition metals such as Zr and Ti in Al, form metastable, coherent L1₂ trialuminides that may act as sites for heterogeneous nucleation and aid in formation of fine-equiaxed grains and thus crack-free microstructure. Furthermore, precipitation strengthening could also be achieved with these trialuminides. Although such grain-refinement and strengthening effects can also be achieved with Sc-containing Al-alloys, Sc is a scarce and very expensive element and hence would add to alloy costs. To facilitate eutectic solidification at the terminal stage, Ni has been added, which at about 6 wt. %, forms a low melting-point Al—Al₃Ni eutectic. Based on hot susceptibility index (HSI), freezing range (calculated from Scheil-Gulliver solidification simulations (SGSS)) and factors affecting precipitation, an Al-3Ni-1Ti-0.8Zr (wt. %) composition, hereinafter referred to as Al—Ni—Ti—Zr alloy, was finalized and gas-atomized.

Additional information and data supporting the invention can be found in the following publication by the inventors: Additive Manufacturing, 2021, 42, 102002 and its Supporting Information, which is incorporated herein by reference in its entirety.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the end-points of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture.

An “effective amount” refers to an amount effective to bring about a recited effect, such as an amount necessary to form products in a reaction mixture. Determination of an effective amount is typically within the capacity of persons skilled in the art, especially in light of the detailed disclosure provided herein. The term “effective amount” is intended to include an amount of a compound or reagent described herein, or an amount of a combination of compounds or reagents described herein, e.g., that is effective to form products in a reaction mixture. Thus, an “effective amount” generally means an amount that provides the desired effect.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation or limitations which is not specifically disclosed herein.

The term “alloy” refers to a solid or liquid mixture of two or more metals, or of one or more metals with certain metalloid elements, e.g., silicon.

The term “dendrite” refers to a characteristic tree-like structure of crystals that grows as molten metal solidifies.

The term “eutectic” refers to a homogeneous solid mix of atomic and/or chemical species forming a super lattice having a unique molar ratio between the components. At the unique molar ratio, the mixtures melt as a whole at a specific temperature—the eutectic temperature. At other molar ratios, one component of the mixture will melt at a first temperature and the other component(s) will melt at a higher temperature.

The term “microstructure” refers to the fine structure of an alloy (e.g., grains, cells, dendrites, rods, laths, lamellae, precipitates, etc.) that can be visualized and examined with a microscope at a magnification of at least 25×. Microstructure can also include nanostructure, i.e., structure that can be visualized and examined with more powerful tools, such as electron microscopy, atomic force microscopy, X-ray computed tomography, etc.

The term “Vickers (micro)hardness” refers to a hardness measurement determined by indenting the test material with a pyramidal indenter, particular to Vickers hardness testing units, subjected to a load of 50 to 1000 gf for a period of time and measuring the resulting indent size. Vickers hardness may be expressed in units of Hv.

The term “yield strength” or “yield stress” refers to the stress a material can withstand without permanent deformation; the stress at which a material begins to deform plastically.

The term “alpha aluminum” refers to a solid-solution aluminum phase with a FCC crystal structure

### EMBODIMENTS OF THE INVENTION

This disclosure provides an aluminum alloy represented by Formula I:

Al—Ni—Ti—Zr (I);

wherein
Al is about 90.8 wt. % to about 98.1 wt. %;
Ni is about 1 wt. % to about 6 wt. %;
Ti is about 0.5 wt. % to about 2 wt. %; and
Zr is about 0.4 wt. % to about 1.2 wt. %.

In the following embodiments, the wt. % of aluminum (Al) makes up the difference in the total weight of the alloy where the total wt. % is 100. In some embodiments, the preferred amount of Al is 95.2 wt. %. In some embodiments, the preferred amount of Nickel (Ni) is 2.6-3.4 wt. %. In some embodiments, the preferred amount of Titanium (Ti) is 0.8-1.2 wt. %. In some embodiments, the preferred amount of Zirconium (Zr) is 0.6-1.0 wt. %.

In some embodiments, Ni is about 1 wt. %, Ti is about 1 wt. %, and Zr is about 0.8 wt. %. In some embodiments, Ni is about 2 wt. %, Ti is about 1 wt. %, and Zr is about 0.8 wt. %. In some embodiments, Ni is about 3 wt. %, Ti is about 1 wt. %, and Zr is about 0.8 wt. %. In some embodiments, Ni is about 4 wt. %, Ti is about 1 wt. %, and Zr is about 0.8 wt. %. In some embodiments, Ni is about 5 wt. %, Ti is about 1 wt. %, and Zr is about 0.8 wt. %. In some embodiments, Ni is about 6 wt. %, Ti is about 1 wt. %, and Zr is about 0.8 wt. %. In some embodiments, Ni is about 3 wt. %, Ti is about 0.5 wt. %, and Zr is about 0.8 wt. %. In some embodiments, Ni is about 3 wt. %, Ti is about 0.75 wt. %, and Zr is about 0.8 wt. %. In some embodiments, Ni is about 3 wt. %, Ti is about 1.25 wt. %, and Zr is about 0.8 wt. %. In some embodiments, Ni is about 3 wt. %, Ti is about 1.5 wt. %, and Zr is about 0.8 wt. %. In some embodiments, Ni is about 3 wt. %, Ti is about 1 wt. %, and Zr is about 0.4 wt. %. In some embodiments, Ni is about 3 wt. %, Ti is about 1 wt. %, and Zr is about 0.6 wt. %. In some embodiments, Ni is about 3 wt. %, Ti is about 1 wt. %, and Zr is about 0.9 wt. %.

In some embodiments, the recited wt. % may vary by ±0.1 part to ±0.6 parts, or preferably ±0.2 parts to ±0.5 parts. For example, a ±0.2 part variation in the Al-3Ni-1Ti-0.8Zr alloy can be shown as Al-(3±0.2)Ni-(1±0.2)Ti-(0.8±0.2)Zr.

In some embodiments, Zr in Formula I may be replaced with a metal or metalloid from the group consisting of B, Cr, Hf, Sc, Ti, and V. The amount of the replacement metal or metalloid is about 0.1 wt % to about 1.0 wt % or about the same as an amount of Zr disclosed herein.

This disclosure also provides a heterogeneous aluminum alloy comprising Al, Ni, Ti, and Zr wherein the alloy has a microstructure comprising fine grains and an intergranular region, wherein:
the fine grains comprise alpha-aluminum having a nucleus of Al₃Ti, Al₃Zr, or a combination thereof, wherein the edge length of the nucleus is about 50 nanometers to about 150 nanometers;
the size of the fine grains is about 0.4 to about 5 micrometers; and
   the intergranular region comprises Al—Ni eutectic lamellae.

In various embodiments the aluminum alloy has a wt. % of Al, Ni, Ti, and Zr as disclosed herein. In some embodiments, the fine grains comprise equiaxed shaped grains. In some embodiments, the nucleus is cuboidal shaped.

In other embodiments, the microstructure further comprises coarse grains having a length of about 5 micrometers to about 40 micrometers and the width of about 1 micrometer to about 15 micrometers. In some embodiments, the length is about 5 micrometers to about 20 micrometers, or about 20 micrometers to about 40 micrometers. In some other embodiments, the width is about 1 micrometer to about 5 micrometers, about 5 micrometers to about 10 micrometers, or about 10 micrometers to about 15 micrometers.

In additional embodiments, the microstructure comprises about 60 wt. % to about 70 wt. % fine grains and about 30 wt. % to about 40 wt. % coarse grains. In other embodiments, about 65 wt. % are fine grains and about 35 wt. % are coarse grains.

In other embodiments, Al is about 95.2 wt. %, Ni is about 3 wt. %, Ti is about 1 wt. %, and Zr is about 0.8 wt. %.

In some embodiments, one or more metals are selected from the group consisting of aluminum, iron, nickel, copper, titanium, magnesium, zinc, silicon, lithium, silver, chromium, manganese, vanadium, and combinations thereof. One or more alloying elements selected from the group consisting of Al, Si, Fe, Cu, Ni, Mn, Mg, Cr, Zn, V, Ti, Ni, or Zr. Other alloying elements may be included (but not limited to) H, Li, Be, B, C, N, 0, Ca, Sc, Co, Zn, Se, Sr, Y, Nb, Mo, Ag, La, Hf, Ta, W, Re, Au, Ce, Nd, and combinations thereof.

Also, this disclosure provides an aluminum alloy represented by Formula II:

Al—Ni—Ti—Zr—Mn (II);

wherein
Al is about 90.2 wt. % to about 97.7 wt. %;
Ni is about 1 wt. % to about 6 wt. %;
Ti is about 0.5 wt. % to about 2 wt. %;
Zr is about 0.4 wt. % to about 1.2 wt. %; and
Mn is about 0.4 wt. % to about 0.6 wt. %.

In some embodiments, Ni is about 3 wt. %, Ti is about 1 wt. %, Zr is about 0.8 wt. %, and Mn is about 0.5 wt. %. In some embodiments, each of the elements may vary by ±0.1 part to ±0.6 parts, or preferably ±0.2 parts to ±0.5 parts.

In some embodiments, the one or more metals forming the alloy composition is made of nanoparticles with the largest dimension between about 1 nm and about 500 nm. In other embodiments, the size of nanoparticles is about 200 nm or less, about 150 nm or less, or about 100 nm or less. In some embodiments, the nanoparticles are at least 50 nm in size.

Additionally, this disclosure provides a method for forming the aluminum alloy comprising printing a metal alloy composition of Al, Ni, Ti, and Zr by laser-powder bed fusion (L-PBF) at a suitable laser-power (P) and scanning-speed (ν) for forming the aluminum alloy according to the disclosure above.

In some embodiments, P is about 150 Watts to about 400 Watts. In other embodiments, P is about 200 Watts, about 250 Watts, about 300 Watts, about 350 Watts, or less than or greater than 750 Watts.

In some embodiments, ν is about 100 millimeters/second to about 2000 millimeters/second. In some other embodiments, ν is about 200 millimeters/second (mm/s), about 300 mm/s, about 400 mm/s, about 500 mm/s, about 600 mm/s, about 700 mm/s, about 800 mm/s, about 900 mm/s, about 1000 mm/s, about 1100 mm/s, about 1200 mm/s, about 1300 mm/s, about 1400 mm/s, about 1500 mm/s, about 1600 mm/s, about 1700 mm/s, about 1800 mm/s, or about 1900 mm/s.

In other embodiments, the aluminum alloy has a relative density of at least 98%, at least 90%, at least 95%, at least 99%, at least 99.5%, or at least 99.7%. In other embodiments, the aluminum alloy has a porosity vol. % of 0.2 or less at about 1 micrometer voxel size. In other embodiments, at about 1 micrometer voxel size, the porosity vol. % is 1 or less, 0.5 or less, 0.4 or less, 0.3 or less, 0.1 or less, or 0.05 or less.

In some other embodiments, the aluminum alloy has a yield strength of about 250 MPa to about 350 MPa, or about 200 MPa to about 400 MPa; an ultimate tensile strength of about 300 MPa to about 400 MPa, or about 250 MPa to about 500 MPa; a Vickers microhardness of at least 100 Hv, at least 50 Hv, at least 150 Hv, or at least 200 Hv; or a combination thereof. Atomized powders of alloys disclosed herein are formed using methods of powder metallurgy that are known to persons skilled in the art.

### Design Approaches for Printability Performance Synergy in Al Alloys for Laser-Powder Bed Additive Manufacturing

Al alloys have now entered an era where their micro structural attributes may be fine-tuned, and where these alloys may be enabled with unique microstructural attributes. These unique microstructural attributes of L-PBF-processed alloys include microstructural hierarchy and designed heterogeneity that stem from features spanning multiple length scales (therefore hierarchical) as well as different phases and domains of differently sized grains (therefore heterogeneous).

Al alloys enabled with such hierarchical and heterogeneous microstructural features may subsequently exhibit additional strengthening mechanisms such as back-stress strengthening and work hardening and thus manifest concurrent enhancements in strength and ductility. Fine-tuning the microstructure to meet structural application-specific needs requires a wide processing window of the alloy so that a required fraction of fine grains and coarse grains may be obtained. The best way to accomplish desirable outcomes is to formulate alloy design strategies that can, (a) facilitate Al alloys with excellent printability at a wide range of process parameters, and (b) facilitate hierarchical and heterogeneous microstructure for enhanced strength-ductility combination.

The current strategies for designing Al alloys for L-PBF focusses on controlling the factors affecting HCS. These strategies involve (a) grain refinement either by heterogeneous nucleation (HN) on potent primary particles or by process parameter based columnar-to-equiaxed transition (CET), and (b) eutectic like solidification—henceforth referred to as eutectic solidification (ES) strategy. Both these approaches lead to improved printability and the very cores of these approaches have emerged as crucial considerations for design of Al alloys for L-PBF AM. L-PBF-processed Al—Si and Al—Ce alloys exemplify such behavior, where although the terminal ES results in excellent printability, these alloys fail to exhibit synergistic strength-ductility.

Excellent printability simultaneously impacts the path to manufacturing robustness, expanded lattice design space and better opportunities for digital qualification. Performance is also critical for structural applications. Therefore, to take full advantage of a technology as disruptive as L-PBF, one has to address approaches in alloy design strategies that maximize printability and performance.

Herein we disclose the origins of columnar growth in L-PBF and its effect on HCS and alloy printability. Furthermore, we draw a correlation between process parameters and growth morphology. Overall, we attempt to identify the challenges to obtain a wider processing window. Further, an alloy design strategy is described that addresses the heterogeneity-printability trade-off and thus may lead to Al alloys with wide processing window and excellent mechanical properties.

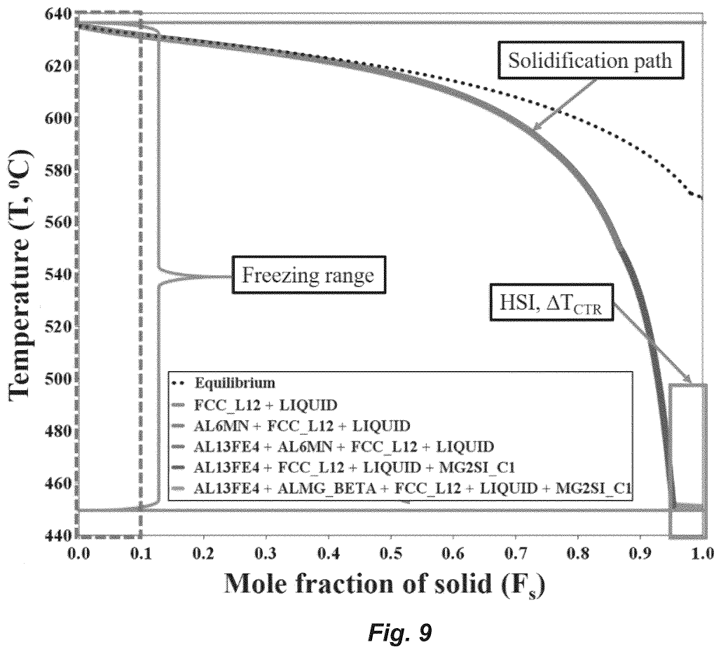

For demonstrating how a T-Fₛ curve is used for assessing alloy printability, an example T-Fₛ curve and solidification path of an Al alloy 5083 are shown in FIG. 9. Various regions of the T-Fₛ curve that are marked or highlighted with shapes have been utilized for deriving indices and predicting HCS of the alloy and consequently its printability. The initial section of T-Fₛ curve marked with a dashed-rectangle (Fₛ<0.1) in FIG. 9 is discussed below.

### A Broader Guide for Design of Al Alloys to Synergize Good Printability, High Strength and Ductility.

Building on the significance of integrating the grain refinement strategy and ES strategy, an assessment of various alloying elements that may lead to a successful integration of the two strategies is important. A successful integration should result in printability-heterogeneity synergy, i.e., wide processing window for crack-free printing and a controlled heterogeneous microstructure. For accomplishing such an integration, two stages of solidification have been identified as critical and the terms initial stage and final stage have following meanings throughout this section:
a) Initial stage of solidification: This stage corresponds to —Fₛ<0.1; formation of potent grain nucleation phases, such as trialuminides (Al₃X) or a ceramic phase, must occur in this stage. The initial stage is indicated by the dashed rectangle towards the left in FIG. 9. For non-eutectic compositions, the solidification of Al does not occur in this stage and thus ample liquid Al is available for solidification through equiaxed growth upon potent grain nucleation phases forming in this initial stage.
b) Final stage of solidification: This later stage of the solidification process extends up to the end of solidification when Fₛ=1. If shrinkage defects are to be avoided then eutectic solidification is preferred through the majority of the solidification stage until the completion of solidification (Fₛ=1), i.e., the majority of the remaining 0.9 fraction of solid after the initial stage must solidify via ES. Notice that the term final stage of solidification is used here instead of terminal stage of solidification. Such usage is deliberate and the difference between the two terms is that the final stage includes within itself the terminal stage of solidification and extends through the completion of solidification (when Fₛ=1) whereas the terminal stage is when the grains have formed (usually Fₛ>0.9).

### An Ideal Al Alloy for L-PBF.

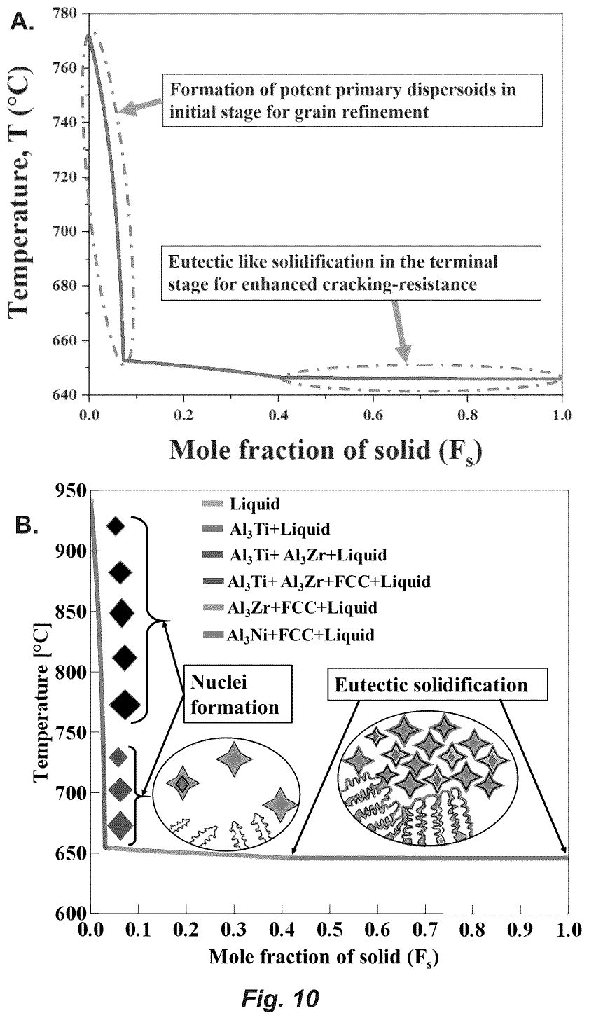

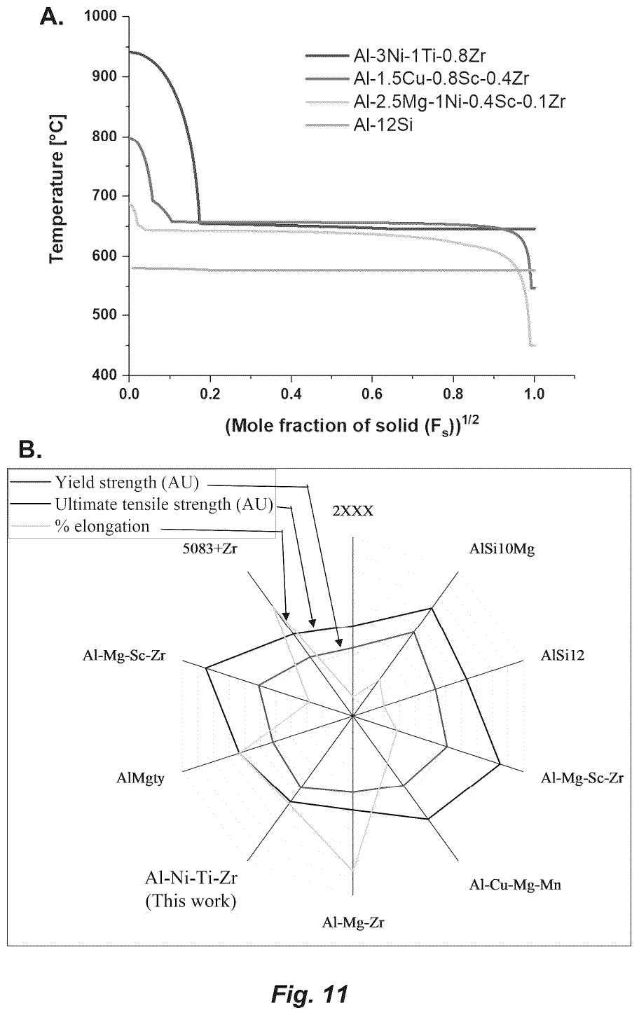

Having established the important attributes of T-Fₛ curves, it is important to correlate these attributes with alloy processing window, and alloy microstructure upon L-PBF processing. An alloy with following attributes will foster grain refinement upon L-PBF: (a) a higher initial rate of formation of constitutionally undercooled zone, (b) a wider initial freezing range, and (c) the capability of forming potent primary dispersoids. As for the final stage of solidification, ideally, the remaining alloy should solidify at a close-to-zero temperature range. A typical T-Fₛ curve of an alloy with good printability should therefore give an appearance of the letter “L”, where the non-horizontal line represents formation of primary dispersoids and the horizontal line represents the formation of a eutectic at the terminal stage of solidification (FIG. 10). A non-horizontal line that is steeper (indicating high rate of formation of constitutionally undercooled zone) and longer (indicating wider initial freezing range), is beneficial for improving printability. Whereas a longer horizontal line aided by the formation of a terminal eutectic (as indicated by the solidification path) would mean lower HCS of the terminal stage. Such an alloy with efficient grain refiners solidifying at the initial stage and a eutectic solidifying at the final stage of solidification would exhibit fine equiaxed grains along with crack-resistant long columnar grains upon LPBF-AM.

Thus, a heterogeneous grain structured (HGSed) microstructure with wide processing window and hierarchical features, such as solute atoms, dislocations, precipitates, cell walls, and grains boundaries, may be obtained leading to an overall microstructural heterogeneity. Due to such microstructural heterogeneity, multiple deformation mechanisms namely, solid solution strengthening, dislocation strengthening, precipitate strengthening, Hall-Petch strengthening, back-stress strengthening and hardening, can be triggered at different stages of deformation to promote strength-ductility synergy. A wider processing window would further allow fine-tuning of the alloy microstructure and subsequently the mechanical properties. For example, area fraction of fine- and coarse-grained regions may be controlled. Subsequently, high strength or ductility, or synergistic high strength and ductility may be obtained depending on the area fraction of fine and coarse grains.

### Results and Discussion

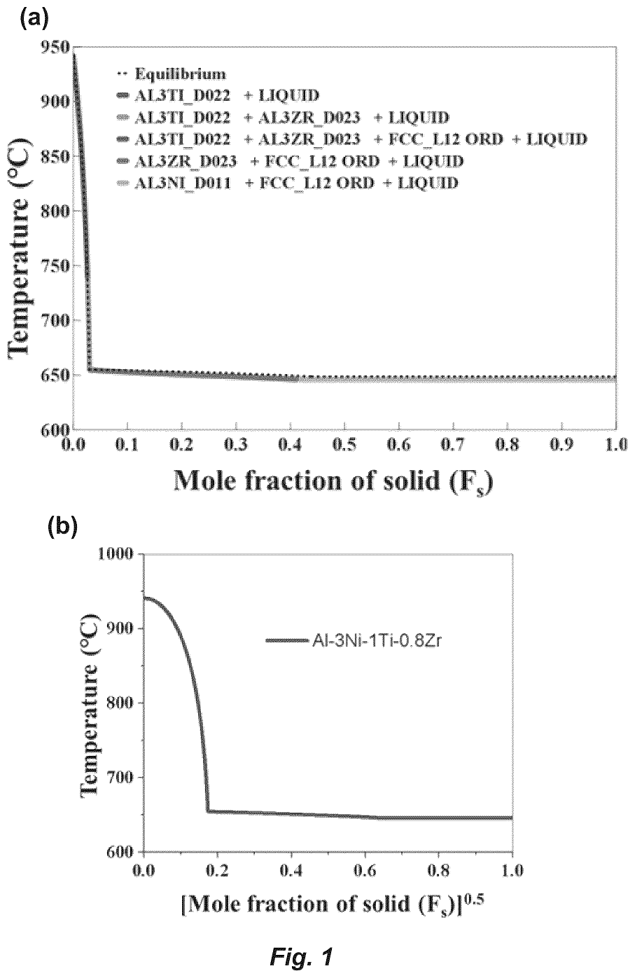

FIG. 1(a) shows the temperature (T) vs mole-fraction (Fₛ) of solid curve and the solidification pathway obtained from SGSS of Al—Ni—Ti—Zr alloy. Formation of Al₃Ti and Al₃Zr precipitates is suggested in the initial stages of solidification; these precipitates are believed to provide sites for heterogeneous nucleation of α-Al grains and result in fine-equiaxed grains. In the terminal stage of solidification, which is most susceptible to hot-cracking, the solidification pathway also predicted the formation of Al₃Ni phase at about 640° C., the temperature at which Al—Al₃Ni eutectic forms. The formation of low melting point eutectic phase starting from when mole fraction of solid (Fₛ) is just about 0.4 through the terminal stage of solidification, implies availability of ample liquid at the terminal stage and that a large portion of solidification (including terminal solidification) occurs at zero freezing-range thus producing minimal thermal strains.

Furthermore, Ni has low solubility in Al, hence despite the high solidification rates in L-PBF, there is a probability that Ni will be rejected in the liquid in interdendritic regions. The fine-equiaxed grains, and formation of terminal eutectic providing ample interdendritic liquid has following implications. As solidification proceeds, solidification shrinkage and thermal contraction induce tensile stress/strain on the mushy zone present between the melt-pool and fully solidified metal. The probability of solidification cracking is high when: a) the mushy zone consists of columnar-dendritic grains, and/or b) only a small amount of interdendritic liquid for backfilling of cracks towards the end of solidification and/or c) the semi-solid alloy spends more time between zero strength temperature (ZST) and zero ductility temperature (ZDT). Since deformation in the mushy zone happens by intergranular slide, less number of available interfaces in case of columnar-dendritic grains reduces the ductility of the mushy zone in that the rearrangement/rotation of columnar-dendrites within the mushy zone to accommodate tensile stress/strain is relatively difficult. On the contrary, presence of fine-equiaxed grains (facilitated by Al₃Ti and Al₃Zr in this alloy) would make the mushy zone more ductile. Additionally, presence of relatively larger amount of liquid in the mushy zone (facilitated by Al—Al₃Ni eutectic in this alloy) would assist in crack-backfilling and a zero brittle temperature range (difference between ZST and ZDT) facilitated by Al—Al₃Ni eutectic in this alloy, would result in minimal thermal strains in the terminal stage of solidification thus inhibiting solidification cracking.

FIG. 1(b) shows T-(Fₛ)^{1/2} curves and suggests approximately zero HSI for the Al—Ni—Ti—Zr alloy (procedures for calculating HIS, see: Process-Dependent Composition, Microstructure, and Printability of Al—Zn—Mg and Al—Zn—Mg—Sc—Zr Alloys Manufactured by Laser Powder Bed Fusion, Metall. Mater. Trans. A 2020) A low value of HSI indicates relatively high grain-growth rate in lateral direction to facilitate grain-bridging and to resist cracking. Since grain refiners are expected to “decorate” only specific sites in the as-built microstructure, remaining sites are expected to solidify into crack-free, coarse-columnar grains. Hence an HGSed as-built microstructure in the Al—Ni—Ti—Zr alloy with excellent printability is expected.

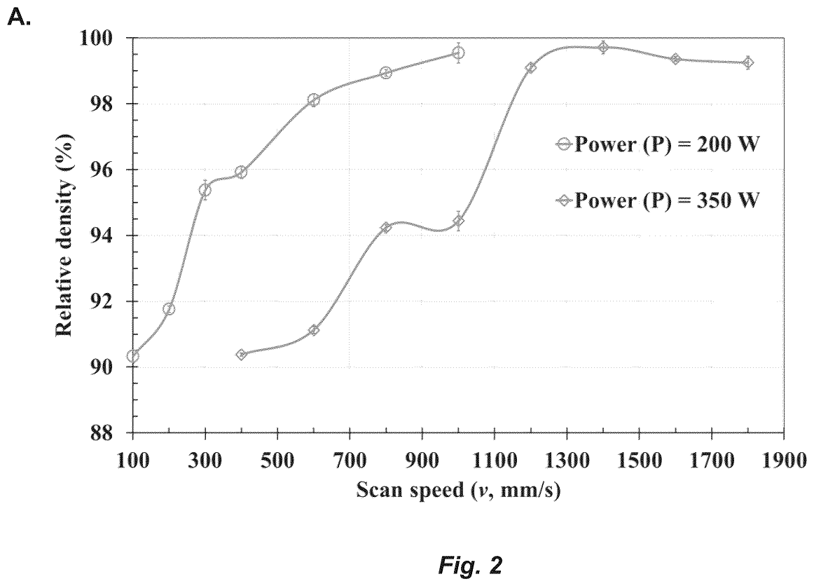

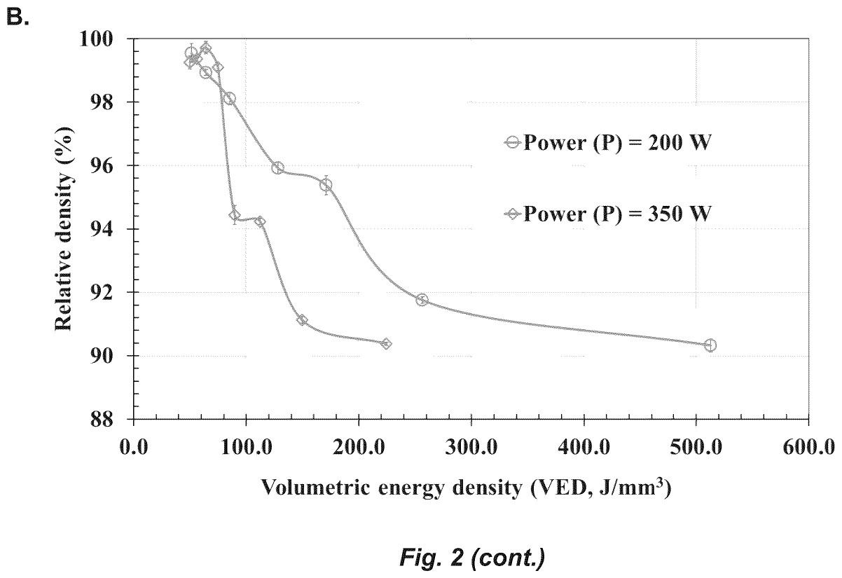

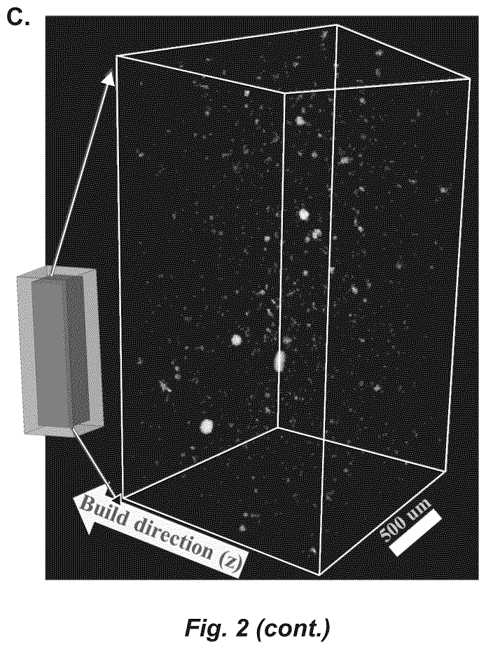

FIG. 2(a) shows variation of relative density with the scan speed (ν) and laser power (P) as determined from optical micrographs of surfaces transverse to the build direction. Different combinations of P and ν used for L-PBF of the Al—Ni—Ti—Zr alloy and the volumetric energy densities (VED) thereof are summarized in Table 1. The VED was determined using equation 1:

$$V E D = \frac{P}{( v \times layer thickness \times hatch distance )} \qquad ( 1 )$$

A rather remarkable absence of cracks at all P-ν combinations was observed, which represents wide processing-window of the Al—Ni—Ti—Zr alloy, its excellent resistance to hot-cracking and thus excellent printability. However, large area fraction of spherical pores at higher VED (higher P and lower ν) were still seen, pointing towards the formation of keyhole pores. Evidently, for a given P, maximum consolidation occurred at higher values of ν (FIG. 2(a)), i.e., at lower VED (FIG. 2(b)). Formation of a high mole fraction of low melting point Al—Al₃Ni eutectic is believed to prevent lack of fusion (LOF) defects at lower energy densities and hence to result in maximum part-consolidation at these energy densities. Thus, the alloy consumes less energy while printing, i.e., the L-PBF of Al—Ni—Ti—Zr alloy is more economical. Maximum relative density of about 99.7% was obtained at 350 W-1400 mm/s; therefore, thereafter the microstructural and mechanical-characterization is performed on the specimen printed at this P-ν combination. A magnified-reconstructed XRM image displays distribution of pores within the volume of the specimen printed at 350 W-1400 mm/s (FIG. 2(c)). Image analysis reveals a porosity vol. % of about 0.1% at about 1 μm voxel size; few round-shaped defects yet no cracks are visible. Such low-porosity content further establishes excellent printability of the Al—Ni—Ti—Zr alloy. A wide processing window allows printing at those P-ν combinations that result in low thermal gradient (G) to growth rate (R) ratios and facilitate formation of equiaxed grains, i.e., high P (associated with low G) and high ν (associated with high R).

TABLE 1
P-ν combinations and energy densities thereof used for
parametric-optimization alongside the obtained relative densities.

| (W) | ν (mm/s) | VED (J/mm³) |
|---|---|---|
| 200 | 100 | 512.8 |
| | 200 | 256.4 |
| | 300 | 170.9 |
| | 400 | 128.2 |
| | 600 | 85.5 |
| | 800 | 64.1 |
| | 1000 | 51.3 |
| 350 | 400 | 224.4 |
| | 600 | 149.6 |
| | 800 | 112.2 |
| | 1000 | 89.7 |
| | 1200 | 74.8 |
| | 1400 | 64.1 |
| | 1600 | 56.1 |
| | 1800 | 49.9 |

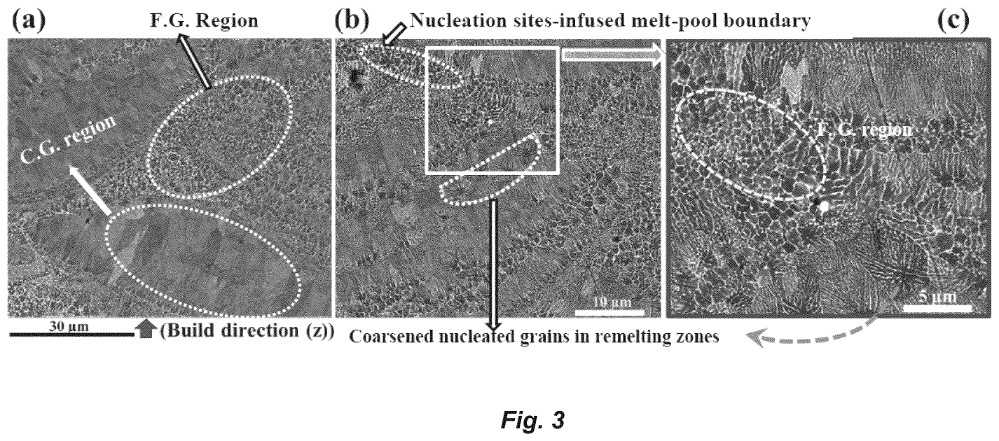

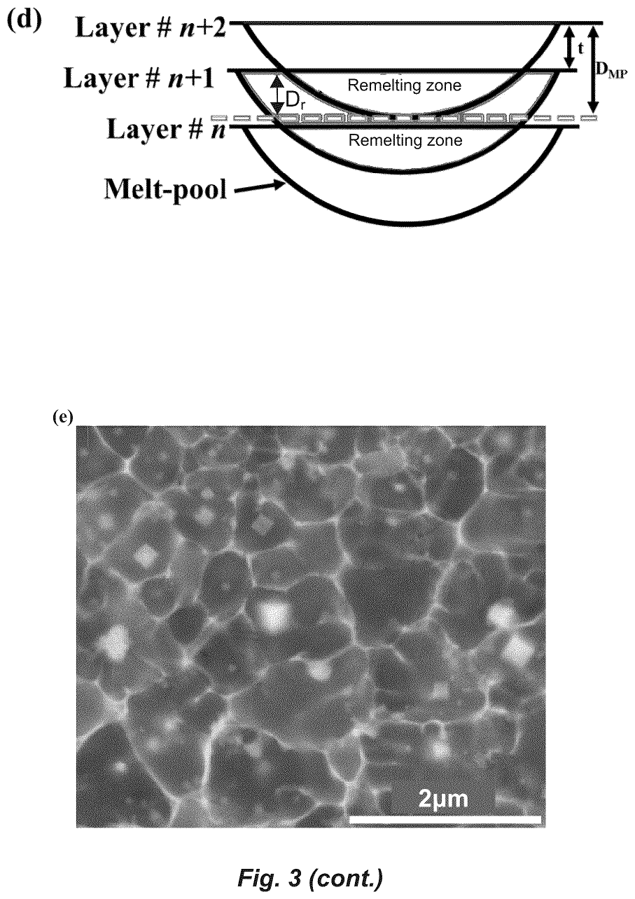

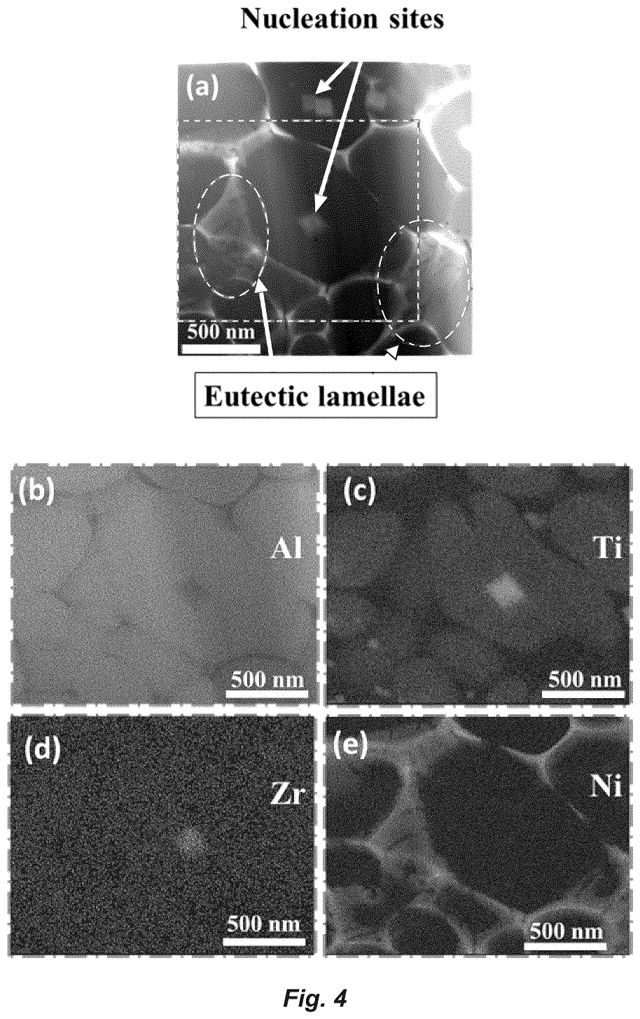

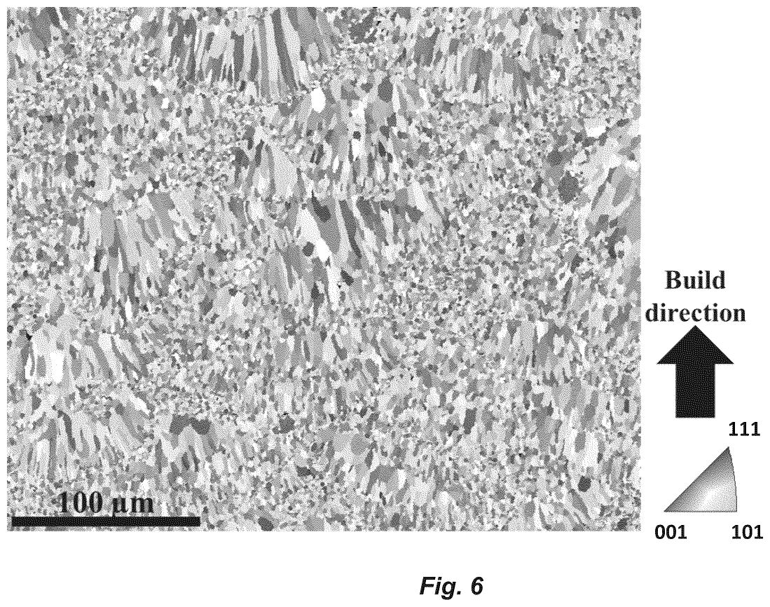

FIG. 3(a) represents the as-built microstructure of the Al—Ni—Ti—Zr alloy from longitudinal plane. A low-magnification electron backscatter diffraction map is provided in FIG. 6. Image analysis revealed that about 65% of the as-built microstructure solidified into fine-grained (F.G.) regions comprising equiaxed grains of size about 0.4-5 μm. The remainder solidified into dendritic coarse-grained (C.G.) region of grain length and width about 5-40 μm and about 1-15 μm respectively. This HGSed as-built microstructure is believed to be facilitated by the availability of heterogeneous nucleation sites in the form of Al₃(Ti,Zr) precipitates at F.G. regions and their absence at C.G. regions. SEM micrographs (FIG. 3(b-c)) and a high-angle annular dark-field scanning-TEM (HAADF-STEM) image (FIG. 4(a)) from a region near melt-pool, confirm cuboidal precipitates of edge length about 100 nm, in the middle of the grains. Energy dispersive X-ray spectroscopy (EDS) maps (FIG. 4(b-d)) validate that these are Al₃(Ti,Zr) precipitates surrounded by α-Al grains and suggest that heterogeneous nucleation of α-Al grains occurred on these sites/precipitates. While wide processing window of the alloy enables printing at high P and ν (small thermal gradient (G) to growth rate (R) ratio), primary Al₃(Ti,Zr) provide heterogeneous nucleation sites and further facilitate columnar-to-equiaxed transition, thus generating a high area fraction of fine equiaxed grains.

On the other hand, the absence of primary Al₃(Ti,Zr) particles from specific locations within a melt pool, contributes to formation of coarse columnar grains. Thus, an HGSed as-built microstructure containing F.G. and C.G. regions is obtained. Notably, the formation of potent nucleants in an early stage of solidification, as suggested by the SGSS (FIG. 1(a)), is important from the perspective of design of alloys with a higher area fraction of equiaxed grains in that the nucleants will simply witness more liquid. Furthermore, in LPBF-AM, due to well defined direction of maximum thermal gradient, columnar grains outgrow their equiaxed counterparts in a growth competition. However, formation of potent nucleants in the early stages facilitates formation of equiaxed grains before the effects of thermal gradients take over to produce a columnar grains-dominant microstructure.

A trend suggesting higher fraction of finer grains near the melt-pool boundaries (FIG. 3(a-c)) follows from a higher population-density of Al₃(Ti,Zr) nucleants at these locations compared to that within the melt-pool (FIG. 3(b-c)). Furthermore, distinctive process-dynamics in L-PBF including formation of remelting-zones (FIG. 3(d)), contribute to this trend. Partial remelting of the previously-solidified pool is necessary to attain a printed part free of LOF defects in L-PBF, thus forming remelting zones. Temperature in the remelting zone represented by zone between layer #n and layer #n+1 in FIG. 3(d), reaches values higher than that in the zone labeled with Dᵣ. Now, at higher temperature, either a) dissolution of Al₃Ti and Al₃Zr nucleants may occur thus resulting in lesser number of potent nucleants for nucleation of α-Al grains or b) coarsening of α-Al grains previously nucleated on these nucleants may occur (FIG. 3(b-c)). In either case, coarser grains will prevail within remelting-zones (FIG. 3(a-d)). Conversely, nucleants may not dissolve within the zone labeled Dᵣ (FIG. 3(d)) thus several heterogeneously-nucleated fine equiaxed α-Al grains may sustain in this zone.

While G/R affects grain morphology, cooling rate (G×R) affects size. Cooling rates at different locations in the melt-pool were calculated using eq. (2):

λ=193 \dot{T}^{-0.55} (2)

where λ is cell-size (μm) and \dot{T} is cooling rate (Ks⁻¹). Cell-size is calculated from high-magnification micrographs using line-intercept method; one such micrograph is shown in FIG. 3(e). \dot{T} varied within the melt-pool (see Table 3); the average \dot{T} of about (2.86±0.32)×10⁵ Ks⁻¹ was obtained and is believed to account for an overall F.G. microstructure with grain size of about 2.1±1.3 μm. At such high non-equilibrium cooling rates, the higher quantity of metastable L1₂ Al₃Ti and Al₃Zr precipitates are likely to form thus assisting in heterogeneous nucleation of α-Al grains.

An Al—Ni-containing lamellar structure in the intergranular region (FIG. 4(a) and FIG. 4(e)) suggests a low-melting-point Al—Al₃Ni eutectic and explains hot-cracking-resistance of columnar grains and high cooling rate obtained during L-PBF of Al—Ni—Ti—Zr alloy. Formation of this low-melting-point eutectic may have enabled printing at lower ν (FIG. 2(a)) and in turn may have resulted in formation of a relatively shallower and overall smaller melt-pool that cools at a faster rate. Notably, SGSS also predicted excellent hot-cracking resistance of Al—Ni—Ti—Zr alloy due to formation of Al—Al₃Ni eutectic at the terminal stage of solidification. Now, for a given layer-thickness (t, μm), a smaller melt-pool depth (D_{MP}, μm) also means smaller remelting zone depth (Dᵣ, μm, FIG. 3(d)) (eq. (3)).

Dᵣ=D_{MP}−t (3)

Smaller values of Dᵣ (enabled by formation of low melting point eutectic) would mean greater numbers of Al₃Ti and Al₃Zr nuclei could survive resulting in relatively higher fraction of F.G. region as compared to when the Dᵣ is higher. Thus, eutectic solidification and heterogeneous nucleation work in tandem to produce crack-free HGSed as-built microstructure via L-PBF. Furthermore, a wide processing-window would allow fine-tuning of the as-built microstructure of Al—Ni—Ti—Zr alloy by allowing printing at different parameters and consequently changing the thermal gradients and growth rate.

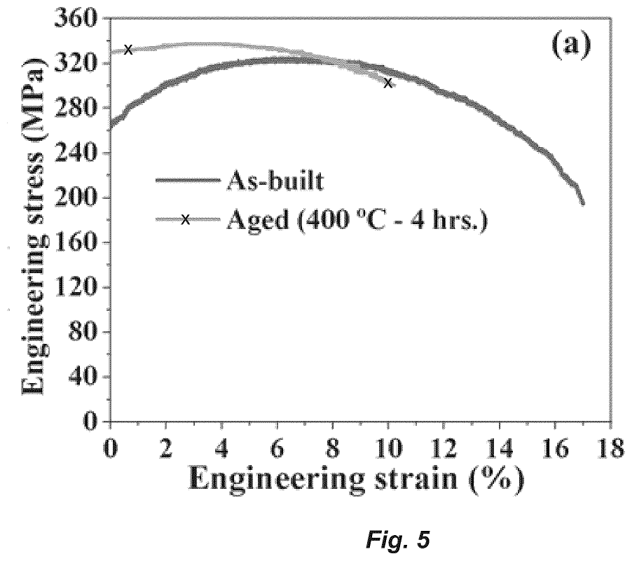

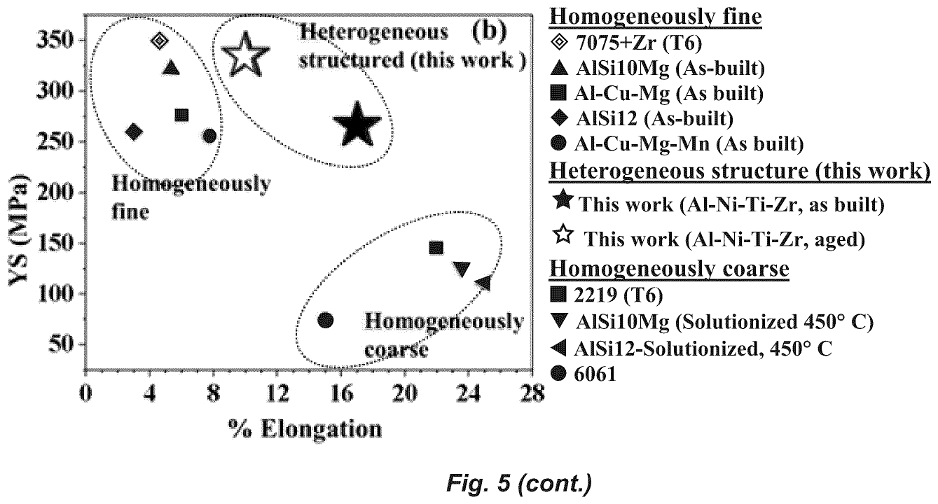

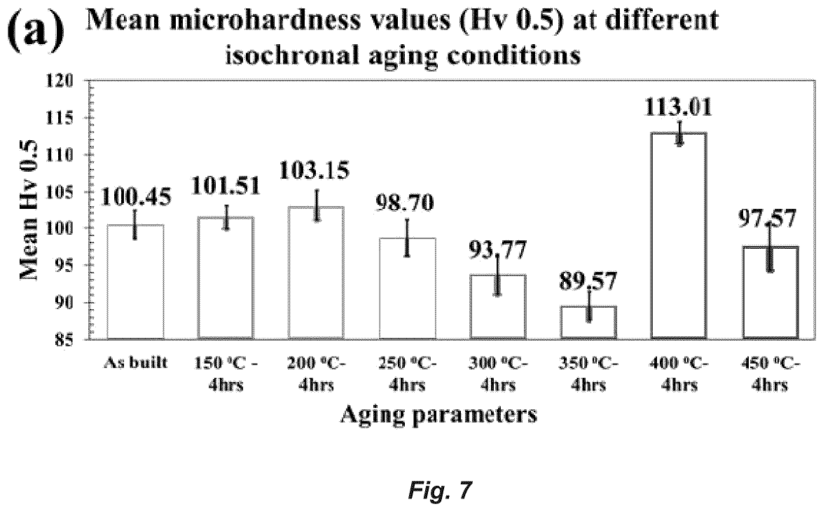

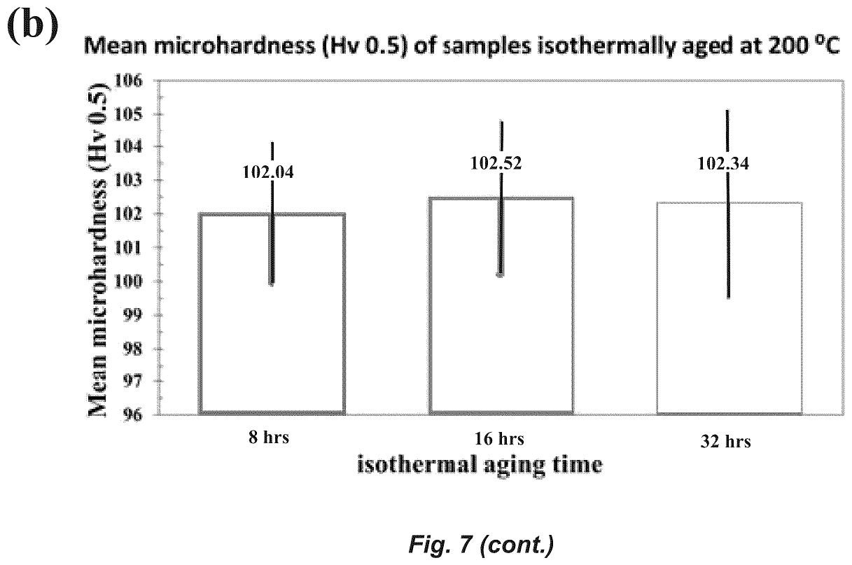

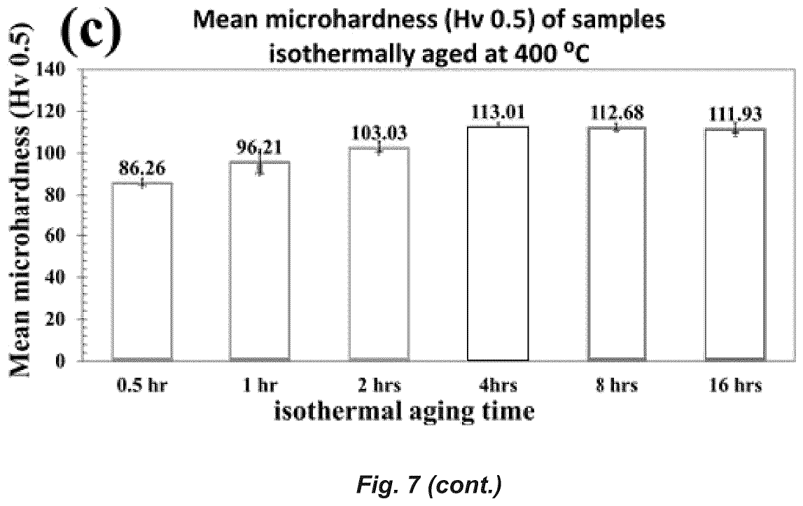

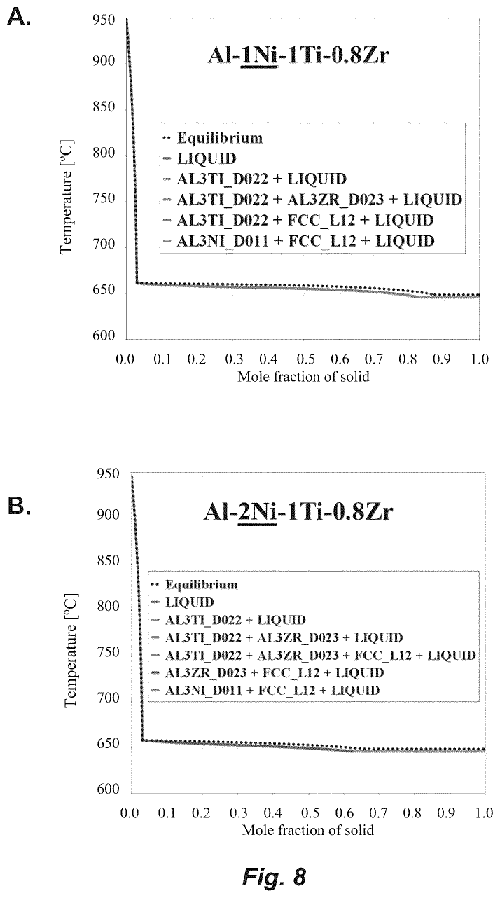

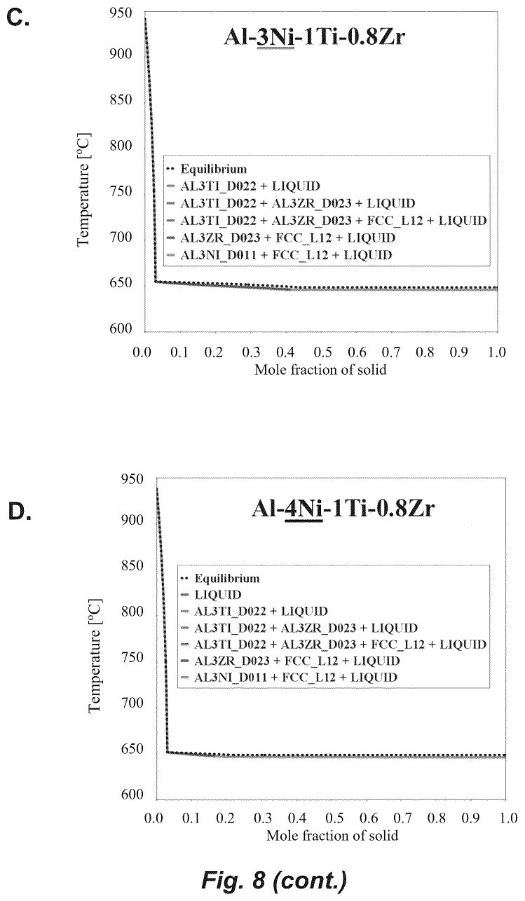

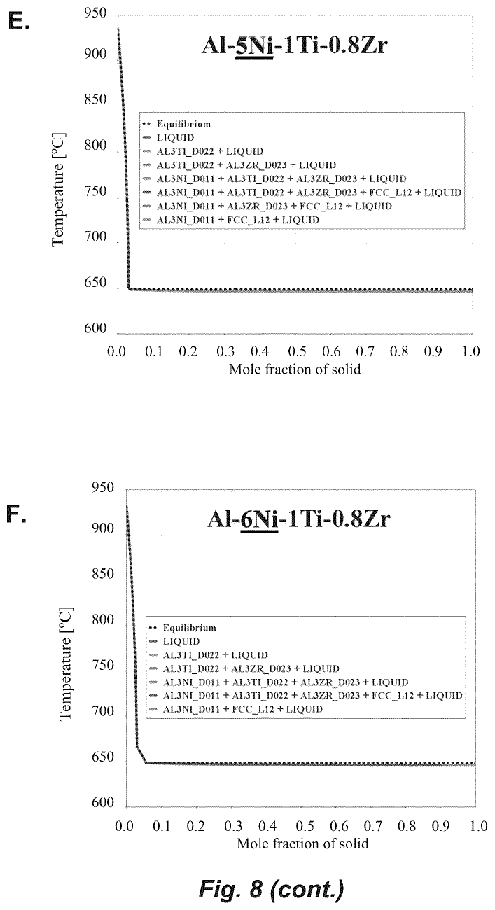

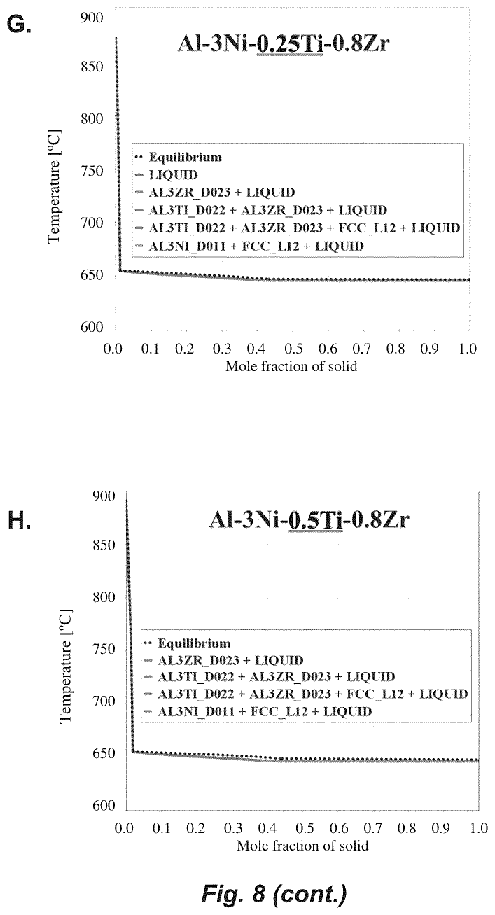

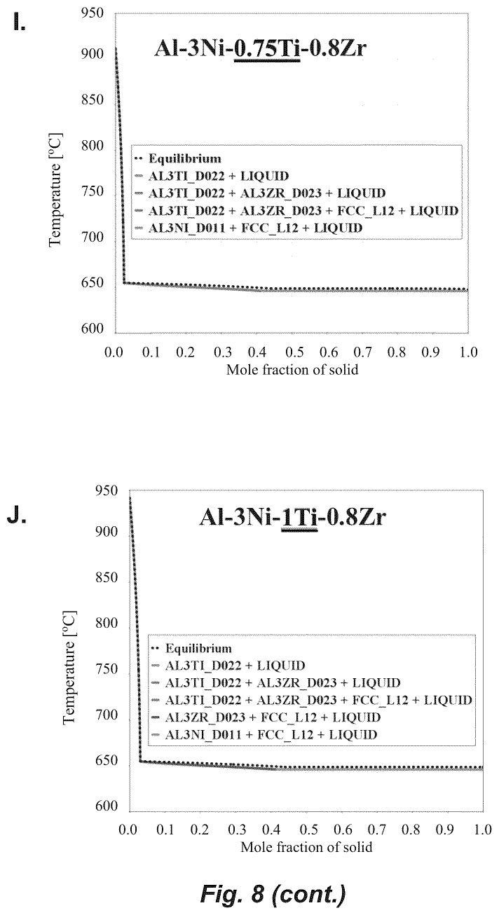

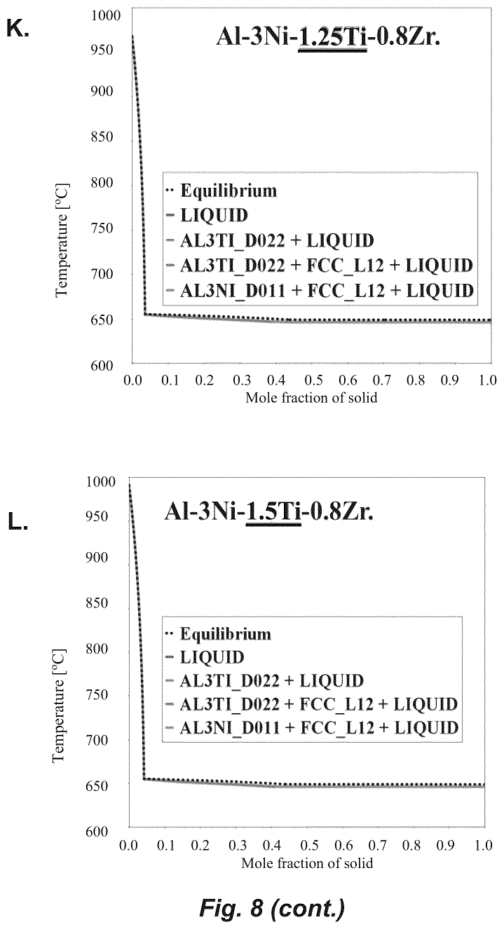

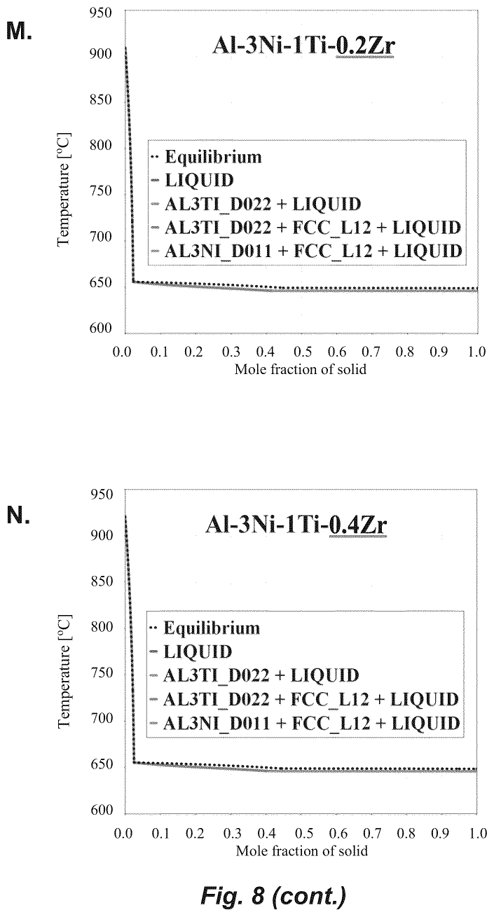

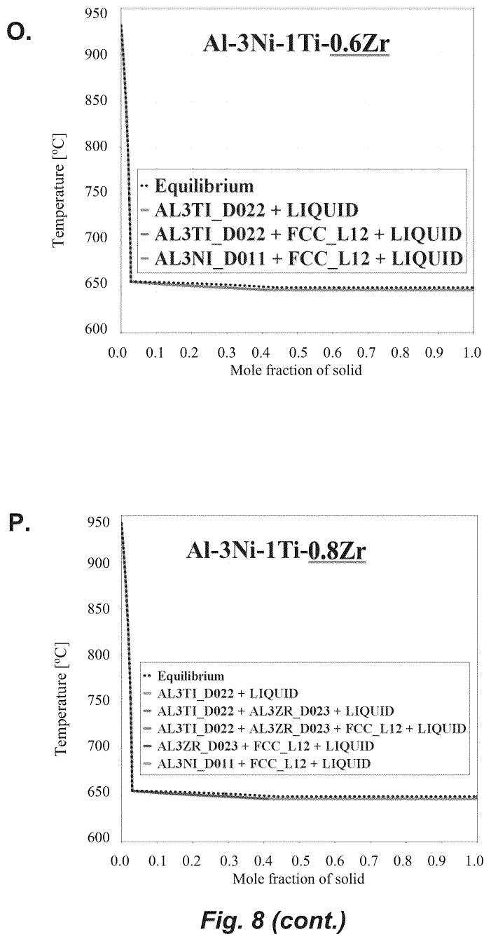

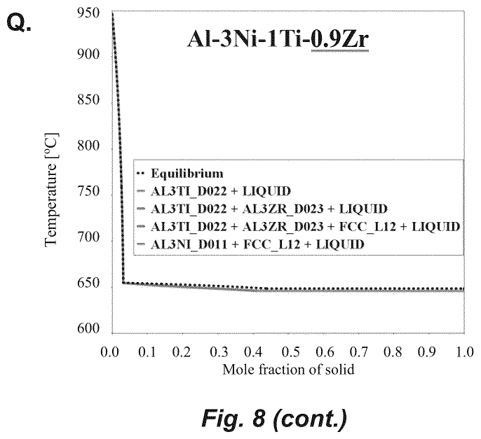

FIG. 5(a) represents engineering tensile stress-strain curves for as-built and aged (400° C.-4 hrs.) mini-tensile specimens of Al—Ni—Ti—Zr alloy. Tensile properties are tabulated in Table 2. Increase in yield strength (YS) upon aging confirms precipitation hardenability of the novel Al—Ni—Ti—Zr alloy (FIG. 7). Besides exhibiting conventionally-known strengthening mechanisms such as precipitation strengthening, Hall-Petch strengthening, and dislocation strengthening, the as-built alloy is believed to exhibit back-stress-induced strengthening due to its HGSed microstructure.

TABLE 2
Tensile properties of Al—Ni—Ti—Zr alloy.

| | YS | Ultimate tensile | % |
|---|---|---|---|
| Alloy-condition | (MPa) | strength (UTS, MPa) | Elongation |
| As-built | 266 ± 1 | 331 ± 9 | 17 ± 1 |
| Aged, 400° C.-4 hrs. | 335 ± 10 | 345 ± 7 | 10 ± 3 |

Furthermore, materials processed with L-PBF often contain high densities of geometrically necessary dislocations (GNDs) that increase with increasing cooling rates. Since cooling rate varies within the melt-pool, varying densities of GNDs must be present. Additionally, varying cooling rate also results in varying sizes of L1₂ precipitates in both F.G. and C.G regions (FIG. 3(b-c)) and varying cell-size in the C.G. region (Table 3). Thus, the HGSed microstructure in as-built Al—Ni—Ti—Zr alloy is supplemented by a hierarchy in GNDs-density, precipitate-size and cell-size. This HGS and microstructural hierarchy at multiple length scales form numerous boundaries within the as-built microstructure and thus constitute an overall heterogeneous microstructure. Such heterogeneous microstructure is likely to result in strain gradients and thus produce back-stress and result in good strength-ductility synergy of the as-built alloy. A high synergistic as-built strength-ductility of Al—Ni—Ti—Zr alloy is compared to other homogenous grain-structured additively manufactured Al-alloys (FIG. 5(b)). Such synergy is attributed to very low porosity content and activation of back-stress strengthening and back-stress work-hardening mechanisms alongside conventional strengthening mechanisms in as-built alloy.

TABLE 3
Varying cooling rate and cell-spacing at
different locations within a melt pool.

| Relative position | | |
|---|---|---|
| in melt pool | Cell-spacing (μm) | Cooling rate (K/s) |
| Bottom | 0.20 ± 0.014 | 2.67 × 10⁵ |
| Middle | 0.20 ± 0.032 | 2.67 × 10⁵ |
| Top | 0.18 ± 0.014 | 3.23 × 10⁵ |

In summary, concepts of grain-refinement and eutectic-solidification were successfully used to design an Al-3Ni-1Ti-0.8Zr (wt. %) alloy that capitalized on non-equilibrium conditions and distinctive process-dynamics in laser-powder-bed fusion. Consequently, a heterogeneous grain-structured as-built microstructure alongside a wide processing-window (indicating excellent printability) was accomplished. Notably, a wide processing-window would make the HGSed microstructure in the Al—Ni—Ti—Zr alloy fine-tunable with L-PBF process-parameters. HGSed as-built microstructure is further assisted by a multi-scale hierarchy, i.e., hierarchy in dislocation-density, precipitate-size, and cell-size, thus forming an overall heterogeneous microstructure. High synergistic strength-ductility in as-built Al—Ni—Ti—Zr alloy is therefore attributed to activation of back-stress strengthening and back-stress work-hardening alongside conventional strengthening mechanisms. Findings suggest an effective strategy for designing HGSed Al-alloys with excellent printability for L-PBF.

Current alloy design strategies either may lead to a heterogeneous microstructure with cracking susceptible columnar growth and a narrower processing window or may lead to excellent printability with homogeneously fine or homogeneously coarse microstructure. This creates a gap between microstructural heterogeneity and printability. Therefore, alloy design strategies that: (a) produce Al alloys with wide processing window; and (b) are conducive to microstructural hierarchy and heterogeneity are desired. An alloy design strategy that integrates grain refinement and eutectic solidification is useful in this regard. As such, during the initial stage (Fₛ<0.1), potent grain refiners must form through a wider temperature range and at a steeper gradient of T-Fₛ curve at Fₛ=0 while a eutectic must form in the final stage through the completion of solidification. T-Fₛ curves are cost-effective and high-throughput computational alternatives to trial and error-based experimental methods for alloy design for L-PBF-AM.

The solidification path obtained from these curves may reveal information about HCS of the alloy in different stages of solidification. For an alloy that integrates the grain refinement strategy (through heterogeneous nucleation) and the ES strategy, the T-Fₛ curve gives an appearance of the letter “L”. Such an alloy enables targeting HCS at multiple stages of solidification and producing a hierarchical and heterogeneous microstructure including fine-equiaxed grains and cracking-resistant coarse columnar grains. Microstructural hierarchy and heterogeneity would allow activation of back-stress strengthening and work hardening. Additionally, owing to the low HCS, such an alloy would exhibit a wider processing window and thus enable fine-tuning of the microstructure and application-specific design of structural components with L-PBF-AM.

The following Example is intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLE

### Example 1. Methods and Materials

SLM 125HL was used to perform L-PBF of the gas-atomized alloy powder (average size about 45 μm). Zeiss X-radia Versa520 was used to perform X-ray microscopy (XRM). Backscattered electron (BSE) images were acquired using FEI NOVA scanning electron microscope (SEM) whereas transmission electron microscopy (TEM) was performed using FEI Tecnai F20-FEG™. Mini-tensile specimens of gage length 5 mm, width 1.25 mm and thickness 1 mm were tested at room temperature and 10⁻³ s⁻¹.

Laser powder bed fusion (L-PBF) process. Fifteen combinations of laser power (P) and scanning-speed (ν) were examined for parametric optimization. Further, relative densities of printed specimens were determined using image analysis of cross sections transverse to the build direction. Hatch width, layer thickness and scanning strategy were kept constant to 130 μm, 30 μm and stripes strategy with 67° interlayer-rotation. The P-ν combination resulting in maximum relative density was used to print a rectangular block of dimensions 100×25×50 mm³. Subsequent microstructural and mechanical characterization was performed on specimens extracted from this block.

Aging-curves for Al—Ni—Ti—Zr alloy. Isochronal aging of the Al—Ni—Ti—Zr alloy was carried out at temperatures ranging from 150-450° C. for 4 hrs. (FIG. 7(a)). Next, Vickers microhardness tests on as-built and aged specimens were performed using Buehler VH3300. Twenty indents were made in each specimen at a constant load of 0.5 kg load; averaged value of microhardness is reported for each specimen in FIG. 7. While a maximum hardness of about 113 Hv is obtained for specimen aged at 400° C.-4 hrs, another hardness peak is observed at 200° C.-4 hrs. Isothermal aging is then carried out at 200° C. (FIG. 7(b)) and 400° C. (FIG. 7(c)). Vickers microhardness of specimens isothermally aged at these two temperatures is recorded using the same method mentioned above. The Al—Ni—Ti—Zr alloy exhibited only small change in hardness when aged at 200° C. for durations of up to about 32 hrs, thus suggesting good coarsening resistance at this temperature. Similarly, at 400° C., upon reaching the maximum hardness value in 4 hrs, hardness reduced by only about 1.08 Hv when aged for prolonged durations.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

1. An aluminum alloy represented by Formula I:
Al—Ni—Ti—Zr (I);
wherein
Al is about 90.8 wt. % to about 98.1 wt. %;
Ni is about 1 wt. % to about 6 wt. %;
Ti is about 0.5 wt. % to about 2 wt. %; and
Zr is about 0.4 wt. % to about 1.2 wt. %.

2. The aluminum alloy of claim 1 wherein Ni is about 1 wt. %, Ti is about 1 wt. %, and Zr is about 0.8 wt. %.

3. The aluminum alloy of claim 1 wherein Ni is about 2 wt. %, Ti is about 1 wt. %, and Zr is about 0.8 wt. %.

4. The aluminum alloy of claim 1 wherein Ni is about 3 wt. %, Ti is about 1 wt. %, and Zr is about 0.8 wt. %.

5. The aluminum alloy of claim 1 wherein Ni is about 4 wt. %, Ti is about 1 wt. %, and Zr is about 0.8 wt. %.

6. The aluminum alloy of claim 1 wherein Ni is about 5 wt. %, Ti is about 1 wt. %, and Zr is about 0.8 wt. %.

7. The aluminum alloy of claim 1 wherein Ni is about 6 wt. %, Ti is about 1 wt. %, and Zr is about 0.8 wt. %.

8. The aluminum alloy of claim 1 wherein Ni is about 3 wt. %, Ti is about 0.5 wt. %, and Zr is about 0.8 wt. %.

9. The aluminum alloy of claim 1 wherein Ni is about 3 wt. %, Ti is about 0.75 wt. %, about 1.25 wt. %, or about 1.5 wt. %, and Zr is about 0.8 wt. %.

10. (canceled)

11. (canceled)

12. The aluminum alloy of claim 1 wherein Ni is about 3 wt. %, Ti is about 1 wt. %, and Zr is about 0.4 wt. %, about 0.6 wt. %., or about 0.9 wt. %.

13. (canceled)

14. (canceled)

15. A heterogeneous aluminum alloy comprising Al, Ni, Ti, and Zr wherein the alloy has a microstructure comprising fine grains and an intergranular region, wherein:
the fine grains comprise alpha-aluminum having a nucleus of Al₃Ti, Al₃Zr, or a combination thereof, wherein the edge length of the nucleus is about 50 nanometers to about 150 nanometers;
the size of the fine grains is about 0.4 to about 5 micrometers; and
the intergranular region comprises Al—Ni eutectic lamellae.

16. The heterogeneous alloy of claim 15 wherein the fine grains comprise equiaxed shaped grains, or wherein the nucleus is cuboidal shaped.

17. (canceled)

18. The heterogeneous alloy of claim 15 wherein the microstructure further comprises coarse grains having a length of about 5 micrometers to about 40 micrometers and the width of about 1 micrometer to about 15 micrometers.

19. The heterogeneous alloy of claim 18 wherein the microstructure comprises about 60 wt. % to about 70 wt. % fine grains and about 30 wt. % to about 40 wt. % coarse grains.

20. The heterogeneous alloy of claim 15 wherein Al is about 95.2 wt. %, Ni is about 3 wt. %, Ti is about 1 wt. %, and Zr is about 0.8 wt. %.

21. An aluminum alloy represented by Formula II:
Al—Ni—Ti—Zr—Mn (II);
wherein
Al is about 90.2 wt. % to about 97.7 wt. %;
Ni is about 1 wt. % to about 6 wt. %;
Ti is about 0.5 wt. % to about 2 wt. %;
Zr is about 0.4 wt. % to about 1.2 wt. %; and
Mn is about 0.4 wt. % to about 0.6 wt. %.

22. The aluminum alloy of claim 21 wherein Ni is about 3 wt. %, Ti is about 1 wt. %, Zr is about 0.8 wt. %, and Mn is about 0.5 wt. %.

23. A method for forming the aluminum alloy comprising printing a metal alloy composition of Al, Ni, Ti, and Zr by laser-powder bed fusion (L-PBF) at a suitable laser-power (P) and scanning-speed (ν) for forming the aluminum alloy of claim 1.

24. The method of claim 23 wherein P is about 150 Watts to about 400 Watts, wherein ν is about 100 millimeters/second to about 2000 millimeters/second, wherein the aluminum alloy has a relative density of at least 98%, wherein the aluminum alloy has a porosity vol. % of 0.2 or less at about 1 micrometer voxel size, or a combination thereof.

25. (canceled)

26. (canceled)

27. (canceled)

28. The method of claim 23 wherein the aluminum alloy has a yield strength of about 250 MPa to about 350 MPa; an ultimate tensile strength of about 300 MPa to about 400 MPa; a Vickers microhardness of at least 100 Hv; or a combination thereof.
